(19) United States
(12) Patent Application Publication
(10) Pub. No.: US 2018/0244898 A1
(43) Pub. Date: Aug. 30, 2018

(54) COMPOSITION

(71) Applicant: ADDIVANT SWITZERLAND GMBH, Reinach Blonay (CH)

(72) Inventors: SATOSHI NAKAGAWA, Chiyoda-ku, Tokyo (JP); Irfaan FOSTER, Brussels (BE); Jonathan HILL, Reinach Blonay (CH)

(21) Appl. No.: 15/754,496

(22) PCT Filed: Sep. 1, 2016
(86) PCT No.: PCT/EP2016/070669

§ 371 Date: Feb. 22, 2018

(30) Foreign Application Priority Data
Sep. 3, 2015 (GB) 1515639.1

(51) Int. Cl. C08K 5/526; C08K 5/134; C08L 71/08; C08L 75/04

(52) U.S. Cl. CPC C08K 5/526; C08L 75/04; C08L 71/08; C08K 5/134

(57) ABSTRACT

The present invention provides the use of a stabilising composition for stabilising a polyol and/or a polyurethane, the stabilising composition comprising: a phenolic antioxidant; and one or more phosphite antioxidants having the structure of formula (I): wherein R₁, R₂ and R₃ are independently selected alkylated aryl groups of the structure formula (II): wherein R₄, R₅ and R₆ are independently selected from the group consisting of hydrogen and C₁ to C₆ alkyl, provided that at least one of R₄, R₅ and R₆ is not hydrogen.

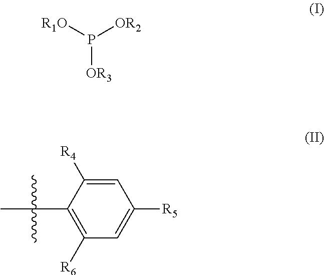

The present invention concerns a stabilising composition. The stabilising composition comprises a phenolic antioxidant and a phosphite antioxidant, and is particularly useful for the stabilisation of polyols and polyurethanes, including polyurethane foam.

Polyurethanes constitute a class of polymers with a range of structures, properties and applications. They all have carbamate or urethane linkages i.e. —NH—C(═O)—O—, and can be made by reacting isocyanates with polyols. Polyurethanes can be tailored according to the choice of isocyanate and polyol, the presence of other components, and the reaction conditions. Polyurethanes include thermoplastic materials and thermosetting materials, and are used to produce flexible and rigid foams, coatings, fibres, moulded products, elastomeric components, seals and adhesives, amongst other products.

Polyurethanes are susceptible to degradation over time. Preparation or processing of the polyurethanes can also bring about or enhance degradation. One of the main causes of degradation, as with many other organic materials, is the reaction with oxygen in a free radical autoxidation cycle. The formation of free radicals can be triggered or enhanced by exposure of the polyurethane to heat or radiation (particularly UV light), or the reaction of the polymer with other components or impurities. The free radicals may then react with oxygen to form peroxy radicals. The peroxy radicals may then react with further polymer species to produce hydroperoxides, which themselves decompose to result in further reactive free radical species.

This type of polymer degradation is often referred to as scorch. Scorch may be detected in a polymer product, for example a polyurethane foam, by the appearance of darker regions in the polymer.

Antioxidants are often used to break the polymer degradation cycle, thus reducing the amount of scorch. Some antioxidants, known as primary antioxidants, are designed to react with peroxy radicals. Other antioxidants, known as secondary antioxidants, are designed to react with hydroperoxides.

Types of primary antioxidants include sterically hindered phenols and aminic compounds, in particular secondary arylamines, for example those disclosed in U.S. Pat. No. 4,824,601. It is known to use these two types of primary antioxidants in combination for the stabilisation of polyurethanes.

Our co-pending application GB 1403714.7 discloses a stabilising composition for polymeric materials, in particular polyurethane, comprising at least one secondary arylamine having the formula I:

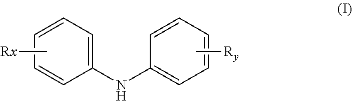

wherein: the or each R, which may be the same or different, independently denotes an optionally substituted higher aliphatic hydrocarbyl group; x and y are each independently from 0 to 5 provided that at least one of x and y is at least 1; and a phenolic antioxidant, the composition and/or the secondary arylamine being a liquid at ambient conditions and being substantially free from diphenylamine and/or from lower alkylated diphenylamine antioxidants.

US2005/004275 discloses a stabiliser composition comprising a 3-arylacrylate, a sterically hindered monomeric amine, a sterically hindered phenol, a chromane derivative, and an organic phosphite and/or phosphonite.

Although stabilising compositions comprising a phenolic component and an aminic component have demonstrated effective in-process stabilisation of polyurethanes, in particular good scorch performance, there are regulatory concerns surrounding the use of aminic components in such compositions. In particular, there are regulatory concerns surrounding diphenylamine, which is a precursor for many aminic antioxidants and is often present in aminic antioxidants in residual amounts.

In addition, amine-containing stabilising compositions tend to exhibit poor gas fading performance, for example when exposed to pollutant gases such as oxides of nitrogen (NOx). To avoid the use of aminic components, it has been contemplated to use a phosphite component in their place. However, the use of phosphites is limited as a result of their hydrolytic instability. Thus, phosphite additives have typically been used as ‘post treatment’ stabilisation packages i.e. they are added immediately prior to polyurethane preparation.

WO 2005/054328 discloses a composition comprising a polyether polyol, a polyester polyol or a polyurethane susceptible to oxidative, thermal or light-induced degradation; and at least a liquid compound of the formula I

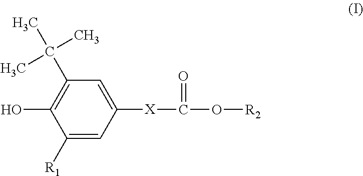

wherein R₁ is C₁-C₄ alkyl, R₂ is a branched C₁₂-C₂₅ alkyl, and X is C₁-C₈ alkylene or C₁-C₄ alkyl substituted C₂-C₈ alkylene.

In this document, it is stipulated that phosphites, such as for example diphenyl isodecyl phosphite (DPDP) or phenyl diisodecyl phosphite (PDDP), are post added as antioxidants or antiscorch systems to the base stabilised polyether polyols at the mixing head prior to the foaming, in relative high concentrations.

GB1560863 discloses a composition comprising an organic polymer containing hetero atoms, double bonds or aromatic rings and having incorporated therein as stabiliser a triaryl phosphite and a phenolic antioxidant.

CN104327241 discloses a polyurethane prepolymer prepared from 100-200 parts of polyether polyol, 0.05-2 parts of a phenolic antioxidant, 0.05-0.2 parts of a phosphite antioxidant, and 20-50 parts of TDI.

WO2015/032033 discloses an antioxidant composition comprising: (1) a hindered phenol, (2) a phosphite ester or thioester, (3) an acid scavenger, (4) a sulphite or hydrosulphite or sulphide, wherein the weight ratio of the raw materials is as follows: hindered phenol:phosphite ester or thioester:acid scavenger:sulphite or hydrosulphite or sulphide is 1:1-4:0.5-2:0.5-3.

However, the phenolic/phosphite stabilising compositions of the prior art tend to be highly emissive, in particular with regard to volatile organic compounds. The phenolic/phosphite stabilising compositions of the prior art typically contain trace amounts of free phenol, and in the case of stabilising compositions including tris(nonphenyl) phosphite, trace amounts of nonylphenol.

There is now a strong demand, particularly from the automotive industry, to reduce the amount of volatile organic compound emissions from stabilising compositions, in particular the amount of free phenol. Further to this, there is a demand to eliminate nonylphenol from stabilising compositions in view of the regulatory concerns that exist in relation to the bioaccumulation of nonylphenol.

In addition, many of the phenolic/phosphite stabilising compositions of the prior art do not achieve the same level of scorch protection as known phenolic/aminic stabilising compositions. In order to improve the scorch protection properties of phenolic/phosphite stabilising compositions, it is known to add a ‘booster’ component to the composition. By ‘booster’ component we mean a non-aminic component which improves the scorch performance of the stabilising composition beyond the base stabilisation of the phenolic component. For example, IRGASTAB® PUR68 is an industry bench-mark stabilising composition utilising a ‘booster’ component.

Thus, there is a need for antioxidant stabilising compositions which overcome the above-identified problems associated with the prior art stabilising compositions, and which satisfy the requirements of an antioxidant stabilising composition with regard to shelf-life, sensitivity to hydrolysis, in-process stabilisation, scorch protection, colour properties, volatility and protection against light and pollutant gases.

According to a first aspect of the present invention there is provided the use of a stabilising composition for stabilising a polyol and/or a polyurethane, the stabilising composition comprising:
a) a phenolic antioxidant; and
b) one or more phosphite antioxidants having the structure of formula I:

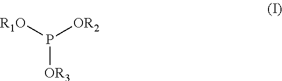

wherein R₁, R₂ and R₃ are independently selected alkylated aryl groups of the structure:

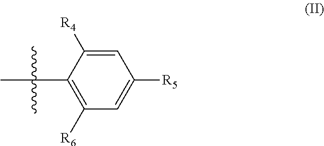

wherein R₄, R₅ and R₆ are independently selected from the group consisting of hydrogen and C₁ to C₆ alkyl, provided that at least one of R₄, R₅ and R₆ is not hydrogen.

According to a second aspect of the present invention there is provided a stabilised composition, comprising:
a) a polyol and/or a polyurethane; and
b) a stabilising composition comprising:
   i. a phenolic antioxidant; and
   ii. one or more phosphite antioxidants having the structure of formula I:

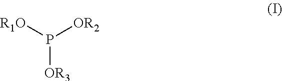

wherein R₁, R₂ and R₃ are independently selected alkylated aryl groups of the structure:

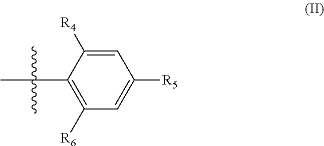

wherein R₄, R₅ and R₆ are independently selected from the group consisting of hydrogen and C₁ to C₆ alkyl, provided that at least one of R₄, R₅ and R₆ is not hydrogen.

According to a third aspect of the present invention there is provided a stabilising composition, comprising:
a) a phenolic antioxidant; and
b) one or more phosphite antioxidants having the structure of formula I:

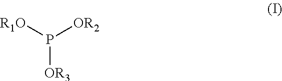

wherein R₁, R₂ and R₃ are independently selected alkylated aryl groups of the structure:

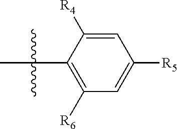

wherein R₄, R₅ and R₆ are independently selected from the group consisting of hydrogen and C₁ to C₆ alkyl, provided that at least one of R₄, R₅ and R₆ is not hydrogen.

The description that follows is applicable, where appropriate, to the first, second and third aspects of the present invention.

In this context, the term ‘stabilising composition’ means an antioxidant stabilising composition.

The inventors of the present invention have surprisingly found that a stabilising composition comprising a phenolic antioxidant and one or more phosphite antioxidants as herein described, can be used to stabilise a polyol and/or a polyurethane. Advantageously, the stabilising composition has an extremely low contribution to volatile organic compounds (VOC) and extremely low gaseous and condensable emissions (FOG), and exhibits surprisingly high levels of scorch performance when used to stabilise a polyol and/or a polyurethane. In addition, the stabilising composition is substantially free from phenol and nonylphenol.

Further advantageously, the stabilising compositions of the present invention exhibit good hydrolytic and thermal stability and are thus, not limited to use as a post treatment stabilisation package during polyurethane production. Rather, the stabilising composition of the present invention may be used as a base stabilisation package, for example it may be added to the precursor polyol, and/or it may be used as a post treatment stabilisation package.

Where the stabilising composition of the present invention is used as a post treatment stabilisation package, it may be used in combination with a base stabilisation package, for example IRGASTAB® PUR55 or ANOX® PP18.

The stabilising composition may be used to replace current commercial post treatment stabilisation packages, for example IRGASTAB® PUR55 or IRGASTAB® PUR68 (both available from BASF). Both of these stabilising packages include IRGANOX® 1135 (Benzenepropanoic acid, 3,5-bis(1,1-dimethyl-ethyl)-4-hydroxy-,C7-C9 branched alkyl esters) which is known to be a significant contributor to FOG. Advantageously, by replacing such post treatment stabilisation packages with the stabilising composition of the present invention, FOG emissions are significantly reduced.

The stabilising composition of the present invention may be used as both the base stabilisation package and the post treatment stabilisation package.

It has unexpectedly been found that the above advantages of the stabilising composition, in particular the high level of scorch performance, can be realised without the use of a ‘booster’ component i.e. a non-aminic component which improves the scorch performance of the stabilising composition beyond the base stabilisation of the phenolic component, for example PS-1 (BASF). Such ‘booster’ components often lack sufficient solubility in the base antioxidant (e.g. the phenolic and/or phosphite antioxidants) and may require a solubilising agent. Thus, the stabilising composition of the present invention may be more cost effective and easier to manufacture than the current industry bench-mark stabilising compositions involving ‘booster’ components, for example IRGASTAB® PUR68 which includes a benzofuran-2-one (PS-1) as the ‘booster’ component.

Further to this, the stabilising composition of the present invention does not contain any aminic component. This is beneficial since there are regulatory concerns surrounding the use of aminic components in stabilising compositions.

The phenolic antioxidant is preferably a liquid at ambient conditions i.e. at atmospheric pressure (101.325 kPa) and a temperature of 25° C. This may provide the advantage that the phenolic antioxidant can be easily mixed with the one or more phosphite antioxidants to form the stabilising composition.

The phenolic antioxidant may comprise one or more phenolic compounds having the structure of formula II:

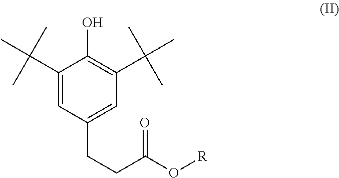

R may be a linear or branched alkyl group having from 12 to 20 carbon atoms. Preferably, R is a linear or branched alkyl group having from 12 to 15 carbon atoms. More preferably, R is a linear or branched alkyl group having from 13 to 15 carbon atoms.

Preferably, the phenolic antioxidant comprises a mixture of two or more phenolic compounds having the structure of formula II, wherein R is different in each phenolic compound.

The phenolic antioxidant may comprise a mixture of two or more phenolic compounds having the structure of formula II, wherein R is different in each phenolic compound and is selected from a linear alkyl group having 12 carbon atoms, a branched alkyl group having 12 carbon atoms, a linear alkyl group having 13 carbon atoms, a branched alkyl group having 13 carbon atoms, a linear alkyl group having 14 carbon atoms, a branched alkyl group having 14 carbon atoms, a linear alkyl group having 15 carbon atoms and/or a branched alkyl group having 15 carbon atoms.

Preferably, the phenolic antioxidant comprises a mixture of phenolic compounds having the structure of formula II, wherein R is different in each phenolic compound and is selected from a linear alkyl group having 13 carbon atoms, a branched alkyl group having 13 carbon atoms, a linear alkyl group having 14 carbon atoms, a branched alkyl group having 14 carbon atoms, a linear alkyl group having 15 carbon atoms and/or a branched alkyl group having 15 carbon atoms.

One particularly preferred phenolic antioxidant comprises C13-C15 linear and branched alkyl esters of 3-(3′5′-di-t-butyl-4′-hydroxyphenyl) propionic acid (ANOX® 1315—CAS 171090-93-0).

Advantageously, the phenolic antioxidants described above all have a low contribution to VOC and FOG.

The one or more phosphite antioxidants have the structure of formula I:

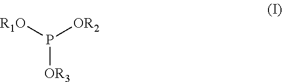

wherein R₁, R₂ and R₃ are independently selected alkylated aryl groups of the structure:

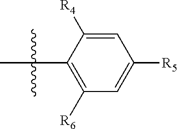

wherein R₄, R₅ and R₆ are independently selected from the group consisting of hydrogen and C₁ to C₆ alkyl, provided that at least one of R₄, R₅ and R₆ is not hydrogen.

The C₁ to C₆ alkyl may be selected from methyl, ethyl, propyl, butyl, pentyl, hexyl and/or isomers thereof, for example isopropyl, isobutyl, sec-butyl, tert-butyl, isopentyl, tert-pentyl and/or neopentyl.

Preferably, at least one of R₄, R₅ and R₆ in the phosphite antioxidant may be selected from the group consisting of tert-butyl and/or tert-pentyl.

Preferred phosphite antioxidants may comprise the structure:

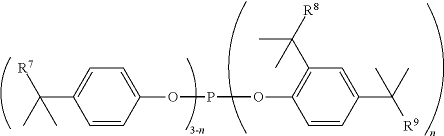

wherein R₇, R₈ and R₉ are independently selected from methyl and ethyl groups, and wherein n is 0, 1, 2 or 3.

Particularly preferred phosphite antioxidants may be selected from the group consisting of tris-4-tert-butyl phenyl phosphite; tris 2,4-di-tert-butyl phenyl phosphite; bis(4-tert-butylphenyl)-2,4-di-tert-butylphenyl phosphite; bis(2,4-di-tert-butylphenyl)-4-tert-butylphenyl phosphite; tris 4-tert-pentyl phenyl phosphite; tris 2,4-di-tert-pentyl phenyl phosphite; bis(4-tert-pentylphenyl)-2,4-di-tert-pentylphenyl phosphite; and/or bis(2,4-di-tert-pentylphenyl)-4-tert-pentylphenyl phosphite.

The stabilising composition may comprise a blend of at least two, at least three or at least four different phosphite antioxidants as herein described.

The blend of phosphite antioxidants may be a liquid at ambient conditions i.e. at atmospheric pressure (101.325 kPa) and a temperature of 25° C.

The one or more phosphite antioxidants may be prepared by reacting a phosphorous trihalide (denoted PZ₃), for example phosphorous trichloride or phosphorous tribromide, with the appropriate alkylated phenol or mixture of alkylated phenols, for example a butylated and/or amylated phenol. A process for preparing the one or more phosphite antioxidants is outlined in WO 2007/149143 which is incorporated herein by reference.

Advantageously, the one or more phosphite antioxidants exhibit low levels of residual VOC. Without wishing to be bound by any such theory, it is believed that the low levels of residual VOC may result from the process used to prepare the one or more phosphite antioxidants. More specifically, the one or more phosphite antioxidants can be prepared by the direct reaction of a phosphorous trihalide with the appropriate alkylated phenol or mixture of alkylated phenols. This process achieves a high product yield and thus, the phosphite antioxidant(s) only contain very small amounts of alkylated phenol (a VOC). The process results in substantially no phenol in the product. The process results in no nonylphenol in the product.

Thus, when the one or more phosphite antioxidants is combined with the phenolic antioxidant, which also exhibits a low contribution to VOC and FOG, the resulting stabilising composition has a low contribution to VOC and FOG i.e. is a low-emissive composition. It has surprisingly been found that the contribution to VOC and FOG is significantly lower than that of industry bench-mark phenolic/phosphite stabilising compositions, including those which utilise a ‘booster’ component.

The weight ratio of the phenolic antioxidant to the one or more phosphite antioxidants in the stabilising composition may be from 30:70 to 70:30; from 35:65 to 65:35; from 40:60 to 60:40; from 45:55 to 55:45; or the weight ratio may be 50:50 (i.e. 1:1).

The stabilising composition is preferably a liquid at ambient conditions i.e. at atmospheric pressure (101.325 kPa) and a temperature of 25° C. This may provide the advantage of the stabilising composition being easily mixed with a polyol and/or a polyurethane.

The stabilising composition according to the present invention is particularly effective at stabilising polyols and/or polyurethanes. The polyol and/or polyurethane may be stabilised against oxidative, thermal and/or radiation (for example light e.g. UV light) induced degradation.

The polyol may, for example, comprise a polyether polyol and/or a polyester polyol. The polyol may be a precursor for a polyurethane.

The polyurethane comprises a polyurethane foam.

The amount of stabilising composition in the stabilised composition may be from about 0.01 to about 10%; from about 0.01 to about 5%; from about 0.01 to about 3.5%; or from about 0.01 to about 2% by weight of the polyol and/or polyurethane.

The invention will now be more particularly described by the following examples.

### EXAMPLES

Table 1 outlines details relating to different stabilising components used in the examples. Hereinafter, the stabilising components will be referred to using the name given in the ‘component’ column.

TABLE 1

| | | CAS | | |
|---|---|---|---|---|
| Component | Type | No. | Description | Structure |
| ANOX ® 1315 | Phenolic | 171090- 93-0 | C13-C15 linear and branched alkyl esters of 3-(3′-5′-di-t-butyl-4′- hydroxylphenyl)propionic acid | 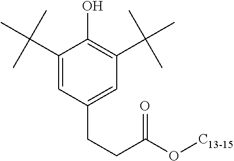 |
| ANOX ® PP18 | Phenolic | 2082- 79-3 | Octadecyl-3-(3′,5′-di-tert- butyl-4′-hydroxyphenyl) propionate | 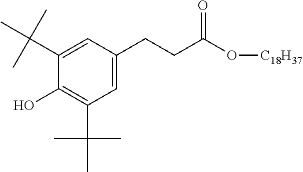 |
| WESTON ® | Phosphite | — | Phosphite antioxidant in | — |
| 705 | | | accordance with the | |
| | | | invention | |
| IRGANOX ® 1135 (BASF) | Phenolic | 125643- 61-0 | Benzenepropanoic acid, 3,5-bis(1,1-dimethyl- ethyl)-4-hydroxy-,C7-C9 branched alkyl esters | 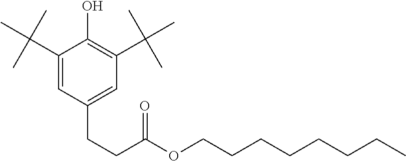 [SMILES: CCCCCCCCOC(=O)CCc1cc(C(C)(C)C)c(O)c(C(C)(C)C)c1] |
| IRGAFOS ® 38 (BASF) | Phosphite | 145650- 60-8 | Bis(2,4-di-tert.-butyl-6- methylphenyl)-ethyl- phosphite | 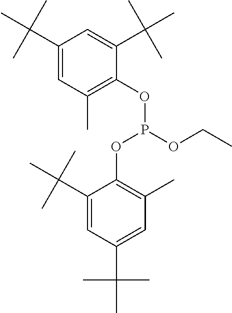 [SMILES: CCOP(Oc1c(C)cc(C(C)(C)C)cc1C(C)(C)C)Oc1c(C)cc(C(C)(C)C)cc1C(C)(C)C] |
| PS-1 (BASF) | Booster | — | 3-(2-actyl-5- isooctylphenyl)-5- isooctylbenzofuran-2- one | 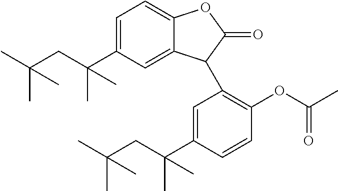 [SMILES: CC(=O)Oc1ccc(C(C)(C)CC(C)(C)C)cc1C1C(=O)Oc2ccc(C(C)(C)CC(C)(C)C)cc21] |
| IRGANOX ® 5057 | Aminic | 68411- 46-1 | Benzenamine, N-phenyl, reaction products with 2,4,4-trimethylpentene | 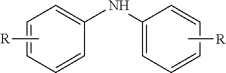 |
| | | | | R = H, butyl, octyl |

The following stabilising compositions may be considered as representing industry bench-mark stabilising compositions:
IRGASTAB® PUR55 (BASF)—2:1 blend of IRGANOX® 1135 and IRGANOX® 5057
IRGASTAB® PUR68 (BASF)—7:1:1 blend of IRGANOX® 1135, IRGAFOS® 38 and a benzofuran-2-one (PS-1)
DVS107—blend of an amine and a hindered phenol

### Examples 1 and 2

### Preparation of Stabilised High Density Polyurethane Foams

Two stabilising compositions with the stabilisers shown in Table 2, were prepared by mixing the relative amounts of the stabilisers. The stabilising composition of Example 1 had a phenolic component and a phosphite component, and is in accordance with the present invention. The stabilising composition of Example 2 had a phenolic component, a phosphite component and a booster component. Example 2 represents an industry bench-mark stabilising composition involving a ‘booster’ component, and is a comparative example.

In these examples, the stabilising compositions acted as base stabilisation packages.

TABLE 2

| | | Amount |
|---|---|---|
| | | (per hundred |
| Example | Stabiliser | parts polyol) |
| 1 | ANOX ® 1315 | 0.30 |
| | WESTON ® 705 | 0.30 |
| 2 | IRGANOX ® 1135 | 0.47 |
| | IRGAFOS ® 38 | 0.07 |
| | PS-1 | 0.07 |

For each of the stabilising compositions outlined in Table 2, 0.85 g (0.60 wt. % based on the polyol) of the stabilising composition was dissolved in 141.75 g of a polyether polyol (ALCUPOL® F-4811 manufactured by Repsol). To this, 0.85 g of TEGOSTAB® B8229 (Evonik), 0.23 g of a solution containing DABCO® 33LV (Air Products) and DABCO® BL11 (Air Products), and 2.84 g of deionised water were added and the reaction mixture stirred vigorously for 30 seconds at 1500 rpm. 0.24 g of tin(II) ethylhexanoate (Sigma Aldrich) was added and the reaction mixture stirred again for 15 seconds at 1500 rpm. 42.57 g of isocyanate (Merck, 2,4-toluylene di-isocyanate and 2,6-toluyene di-isocyanate mixture) was added and the reaction mixture stirred vigorously for 10 seconds at 1500 rpm.

The resulting mixture was poured into a 18 cm×16 cm×16 cm box lined with Kraft paper and the exothermic temperature was measured during foaming to a foam block. The foam block was cured at 95° C. in a conventional oven for 30 minutes and allowed to cool to ambient temperature. The density of the foam block was roughly 40 kg/m³.

Each of the foam blocks were analysed for volatile organic compounds (VOC) and gaseous emissions and condensable emissions (FOG) using standard test method VDA 278. The results are shown in Table 3.

TABLE 3

| | Contribution to VOC | Contribution to FOG |
|---|---|---|
| Example | (ppm) | (ppm) |
| 1 | 8 | 3.5 |
| 2 | 21 | 1103 |

It can be seen from the results that the stabilising composition of the present invention (Example 1) contributes far less to VOC and FOG compared to the stabilising composition of the comparative example (Example 2). In addition, there was no detectable amount of free phenol in the foam block prepared using the stabilising composition of Example 1.

### Examples 3 to 7

### Preparation of Stabilised Low Density Polyurethane Foams

Five stabilising compositions with the stabilisers shown in Table 4, were prepared by mixing the relative amounts of the stabilisers. The stabilising compositions of examples 3 and 5 had a phenolic component and a phosphite component, and are in accordance with the present invention. The stabilising compositions of examples 4 and 6 had a phenolic component, a phosphite component and a booster component. Examples 4 and 6 represent an industry bench-mark stabilising composition involving a ‘booster’ component, and are comparative examples. The stabilising composition of Example 7 had a phenolic component and an aminic component, and is a comparative example.

In these examples, the stabilising compositions acted as base stabilisation packages.

TABLE 4

| | | Amount |
|---|---|---|
| | | (per hundred |
| Example | Stabiliser | parts polyol) |
| 3 | ANOX ® 1315 | 0.225 |
| | WESTON ® 705 | 0.225 |
| 4 | IRGANOX ® 1135 | 0.35 |
| | IRGAFOS ® 38 | 0.05 |
| | PS-1 | 0.05 |
| 5 | ANOX ® 1315 | 0.30 |
| | WESTON ® 705 | 0.30 |
| 6 | IRGANOX ® 1135 | 0.47 |
| | IRGAFOS ® 38 | 0.07 |
| | PS-1 | 0.07 |
| 7 | IRGANOX ® 1135 | 0.30 |
| | IRGANOX ® 5057 | 0.30 |

For each of the stabilising compositions outlined in Table 4, 0.63 g (0.60 wt. % based on the polyol) of the stabilising composition was dissolved in 104.5 g of a polyether polyol (ALCUPOL® F-4811 manufactured by Repsol). To this, 0.79 g of TEGOSTAB® B8229 (Evonik), 0.21 g of a solution containing DABCO® 33LV (Air Products) and DABCO® BL11 (Air Products), and 6.53 g of deionised water were added and the reaction mixture stirred vigorously for 30 seconds at 1500 rpm. 0.27 g of tin(II) ethylhexanoate (Sigma Aldrich) was added and the reaction mixture stirred again for 15 seconds at 1500 rpm. 83.2 g of isocyanate (Merck, 2,4-toluylene di-isocyanate and 2,6-toluyene di-isocyanate mixture) was added and the reaction mixture stirred vigorously for 10 seconds at 1500 rpm.

The resulting mixture was poured into a 18 cm×16 cm×16 cm box lined with Kraft paper and the exothermic temperature was measured during foaming to a foam block. Each foam block was either a) cured at 95° C. in a conventional oven for 30 minutes and allowed to cool to ambient temperature, or b) heated in a microwave oven at a pre-determined power level for a pre-determined time to induce temperatures that mimicked those experienced in polyurethane foam production, then cured at 95° C. in a conventional oven. The density of the foam block was roughly 20 kg/m³.

The foam blocks of examples 3 and 4 were subjected to step b) above and the discolouration of the foam due to scorch was measured. The discolouration was measured in terms of Yellowness Index (YI). The lower the YI value, the less discolouration and hence the less scorch. The higher the YI value, the greater discolouration and hence the higher scorch. The results are shown in Table 5.

TABLE 5

| Example | YI Value |
|---|---|
| 3 | 28 |
| 4 | 19 |

It can be seen from the results that the YI value of the foam block with the stabilising composition according to the present invention (Example 3) is comparable to that of the foam block with the industry bench-mark stabilising composition (Example 4).

The foam blocks of examples 5 to 7 were cured at 95° C. in a conventional oven for 30 minutes and allowed to cool to ambient temperature (step a) above). The foam blocks were then exposed to NOx gases at a temperature of 60° C. in accordance with standard test method AATCC Test Method 23-2005. The discolouration after 1 hour, 2 hours and 3 hours was measured in terms of Yellowness Index (YI). The results are shown in Table 6.

TABLE 6

| Example | YI Value (1 h) | YI Value (2 h) | YI Value (3 h) |
|---|---|---|---|
| 5 | 18.26 | 25.56 | 29.91 |
| 6 | 13.70 | 23.70 | 29.53 |
| 7 | 27.61 | — | — |

It can be seen from the results that the YI values at 1 hour, 2 hours and 3 hours for the foam block with the stabilising composition according to the present invention (Example 5) are comparable to those of the foam block stabilised with the industry bench-mark stabilising composition (Example 6). In addition, it can be seen that the foam block with the stabilising composition of the present invention showed less discolouration than that of Example 7.

### Examples 8 to 12

### Oxidation Induction Temperature of Stabilised Polyether Polyols

Stabilising compositions according to the present invention have also been shown to stabilise polyether polyols (the precursor to polyurethane foams). In these examples, the stabilising compositions acted as base stabilisation packages.

Four polyether polyol samples (ALCUPOL® F-4811 manufactured by Repsol) were stabilised using the stabilising compositions outlined in Table 7. The stabilising compositions of examples 8 and 10 had a phenolic component and a phosphite component, and are in accordance with the present invention. The stabilising compositions of examples 9 and 11 had a phenolic component, a phosphite component and a booster component. Examples 9 and 11 represent an industry bench-mark stabilising composition involving a ‘booster’ component, and are comparative examples. The fifth polyether polyol sample (Example 12) had no stabiliser added to it, and acted as the control.

Differential scanning calorimetry was used to determine the Oxidation Induction Temperature (OIT) of the stabilised polyether polyol samples and the control sample. The OIT was measured according to standard test method ASTM 3895, and did not take into account pre-oxidation events. Differential scanning calorimetry was carried out in oxygen and the temperature ranged from 25° C. to 300° C., increasing at a rate of 10° C. per minute. The OIT results are shown in Table 7.

TABLE 7

| | | Amount | |
|---|---|---|---|
| | | (per hundred | |
| Example | Stabiliser | parts polyol) | OIT (° C.) |
| 8 | ANOX ® 1315 | 0.3 | 201.27 |
| | WESTON ® 705 | 0.3 | |
| 9 | IRGANOX ® 1135 | 0.47 | 197.23 |
| | IRGAFOS ® 38 | 0.07 | |
| | PS-1 | 0.07 | |
| 10 | ANOX ® 1315 | 0.225 | 195.72 |
| | WESTON ® 705 | 0.225 | |
| 11 | IRGANOX ® 1135 | 0.35 | 195.61 |
| | IRGAFOS ® 38 | 0.05 | |
| | PS-1 | 0.05 | |
| 12 | No stabiliser | — | 145.41 |

From the results it can be seen that the polyether polyol samples stabilised with the stabilising composition according to the present invention (examples 8 and 10) had comparable OIT values to those samples stabilised with the industry bench-mark stabilising composition (examples 9 and 11).

### Examples 13 to 15

### Discolouration of Stabilised Polyether Polyols

Two polyether polyol samples (ALCUPOL® F-4811 manufactured by Repsol) were stabilised using the stabilising compositions outlined in Table 8. The stabilising composition of Example 13 had a phenolic component and a phosphite component, and is in accordance with the present invention. The stabilising composition of Example 14 had a phenolic component, a phosphite component and a booster component. Example 14 represents an industry bench-mark stabilising composition involving a ‘booster’ component, and is a comparative example. The third polyether polyol sample (Example 15) had no stabiliser added to it, and acted as the control.

Accelerated heat aging was carried out on each of the polyether polyol samples for 4 hours at 180° C., and the discolouration was measured using the Yellowness Index (YI). The results are shown in Table 8.

TABLE 8

| | | Amount | |
|---|---|---|---|
| | | (per hundred | YI Value |
| Example | Stabiliser | parts polyol) | (4 h) |
| 13 | ANOX ® 1315 | 0.225 | 2.07 |
| | WESTON ® 705 | 0.225 | |
| 14 | IRGANOX ® 1135 | 0.35 | 2.89 |
| | IRGAFOS ® 38 | 0.05 | |
| | PS-1 | 0.05 | |
| 15 | No stabiliser | — | 1.03 |

From the results it can be seen that both stabilising compositions adversely affect the colour stability of the polyether polyol. However, the polyether polyol sample stabilised with the stabilising composition according to the present invention (Example 13) showed minimal discolouration as indicated by a low YI value, which is comparable to that of the sample stabilised with the industry bench-mark stabilising composition (Example 14).

### Examples 16 and 17

### Viscosity and Thermogravimetric Analysis of Stabilising Compositions

Two stabilising compositions with the stabilisers shown in Table 9, were prepared by mixing the relative amounts of the stabilisers.

TABLE 9

| Example | Stabiliser | Relative Amounts |
|---|---|---|
| 16 | ANOX ® 1315 | 0.5 |
| | WESTON ® 705 | 0.5 |
| 17 | IRGANOX ® 1135 | 0.45 |
| | IRGAFOS ® 38 | 0.05 |
| | PS-1 | 0.05 |

The dynamic viscosity for each of the stabilising compositions was determined using a Brookfield viscometer. In addition, the kinematic viscosity for each of the stabilising compositions was determined using standard test method ASTM 445. The results are shown in Table 10.

TABLE 10

| Ex- | | | | | | | |
|---|---|---|---|---|---|---|---|
| am- | Dynamic Viscosity | | | Kinematic Viscosity | | | |
| ple | 25° C. | 40° C. | 60° C. | 25° C. | 40° C. | 50° C. | 60° C. |
| 16 | 790 | 230 | 58 | 1011 | 260 | 113 | 72 |
| 17 | 1060 | 250 | 53 | 1620 | 300 | 127 | 65 |

It is important for the stabilising compositions to be liquids under operating conditions in order to be easily handled. From the results it can be seen that the stabilising composition according to the present invention (Example 16) has viscosities comparable to the industry bench-mark stabilising composition (Example 17).

Thermogravimetric analysis of each of the stabilising compositions was determined using standard test method ASTM E 1131. The results are shown in Table 11.

TABLE 11

| | ° C. | | |
|---|---|---|---|
| Example | 10% wt. loss | 25% wt. loss | 50% wt. loss |
| 16 | 303.31 | 328.68 | 347.60 |
| 17 | 257.35 | 283.51 | 303.01 |

Thermogravimetric analysis indicates the thermal stability of the stabilising compositions. The thermal stability of the stabilising compositions is important due to the high temperatures e.g. greater than 170° C., that may be experienced during polyurethane production.

From the results it can be seen that the stabilising composition according to the present invention (Example 16) has greater thermal stability compared to the industry bench-mark stabilising composition (Example 17).

### Examples 18 to 33

### Preparation of Stabilised Low Density Polyurethane Foams

In each of the following examples, 100.0 g of a polyether polyol (VORANOL® 8010 manufactured by DOW Chemical Company), 0.45 g of a base stabilisation package and optionally 1.0 g of a post treatment stabilisation package were charged to a beaker and blended for 60 seconds. To this, 1.10 g of TEGOSTAB® B8229 (Evonik), 0.40 g of a solution containing a 3:1 mixture of DABCO® 33LV (Air Products) and DABCO® BL11 (Air Products), and 5.0 g of deionised water were added and the reaction mixture stirred vigorously for 30 seconds at 1500 rpm. 0.3 g of Tin(II) ethylhexanoate (Sigma Aldrich) was added and the reaction mixture stirred again for 15 seconds at 1500 rpm. 62.7 g of isocyanate (Merck, 2,4-toluylene di-isocyanate and 2,6-toluyene di-isocyanate mixture) was added and the reaction mixture stirred vigorously for 5-10 seconds at 1500 rpm.

The resulting mixture was transferred into a 16 cm×16 cm×18 cm box lined with Kraft paper and the exothermic temperature was measured during foaming to a foam block. Once the foam block reached its maximum internal temperature (roughly between 130° C.-145° C.) it was heated in a microwave oven for either 130 seconds, 140 seconds, or 150 seconds, at an average power of 620 W. The foam block was cured at 90° C. in a convection oven for 30 minutes and allowed to cool to ambient temperature. Once cooled, a sample from the foam block was removed and its density measured. The density target of the foam block was roughly 20 kg/m³.

The discolouration (ΔE) of the foam samples was measured using an X-rite Colour Eye 7000A benchtop spectrophotometer. The lower the ΔE value, the less discolouration and hence the less scorch. The higher the ΔE value, the greater discolouration and hence the higher scorch.

The ΔE results for the various combinations of base stabilisation packages and post treatment packages that were tested are shown in Table 12.

TABLE 12

| | | | |
|---|---|---|---|
| Example | Base Package | Post Treatment Package | Average ΔE |

130 seconds

| | | | |
|---|---|---|---|
| 18 | DVS107 | None | 16.5 |
| 19 | DVS107 | DVS111* | 4.1 |
| 20 | ANOX ® PP18 | None | 30 |
| 21 | ANOX ® PP18 | DVS111 | 2.2 |

140 seconds

| | | | |
|---|---|---|---|
| 22 | IRGASTAB ® PUR55 | None | 13.8 |
| 23 | IRGASTAB ® PUR55 | IRGASTAB ® PUR55 | 6.8 |
| 24 | IRGASTAB ® PUR55 | IRGASTAB ® PUR68 | 3.6 |
| 25 | IRGASTAB ® PUR55 | DVS111 | 7.3 |
| 26 | DVS107 | None | 15.4 |
| 27 | DVS107 | DVS111 | 5.7 |
| 28 | ANOX ® PP18 | None | >30 |
| 29 | ANOX ® PP18 | DVS111 | 8.4 |

150 seconds

| | | | |
|---|---|---|---|
| 30 | IRGASTAB ® PUR55 | None | 29 |
| 31 | IRGASTAB ® PUR55 | IRGASTAB ® PUR55 | 11.1 |
| 32 | IRGASTAB ® PUR55 | IRGASTAB ® PUR68 | 7.7 |
| 33 | IRGASTAB ® PUR55 | DVS111 | 5.9 |

*DVS111 is a 1:1 blend of ANOX ® 1315 and WESTON ® 705 which is a stabilising composition according to the present invention

It can be seen from the results that the discolouration values for the stabilising composition according to the present invention are comparable to those of the industry bench-mark post treatment stabilising compositions, IRGASTAB® PUR55 and IRGASTAB® PUR68. Thus, it can be concluded that the stabilising composition according to the present invention is as effective as the industry bench-mark post treatment stabilising compositions for protecting against scorch during polyurethane production.

In addition, the results show that there is a significant reduction in discolouration when the stabilising composition according to the present invention is used as a post treatment stabilisation package, compared to no post treatment stabilisation package being used.

1. A method for stabilising a polyol and/or a polyurethane, comprising the step of adding to the polyol and/or the polyurethane a stabilising composition, wherein the stabilising composition comprises:
a) a phenolic antioxidant; and
b) one or more phosphite antioxidants having the structure of formula I: 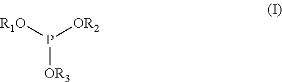
wherein R₁, R₂ and R₃ are independently selected alkylated aryl groups of the structure: 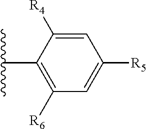
wherein R₄, R₅ and R₆ are independently selected from the group consisting of hydrogen and C₁ to C₆ alkyl, provided that at least one of R₄, R₅ and R₆ is not hydrogen.

2. The method according to claim 1, wherein the C₁ to C₆ alkyl is selected from methyl, ethyl, propyl, butyl, pentyl, hexyl, isopropyl, isobutyl, sec-butyl, tert-butyl, isopentyl, tert-pentyl and/or neopentyl; and/or
wherein at least one of R₄, R₅ and R₆ in the phosphite antioxidant is selected from the group consisting of tert-butyl and/or tert-pentyl; and/or
wherein the one or more phosphite antioxidants comprises: 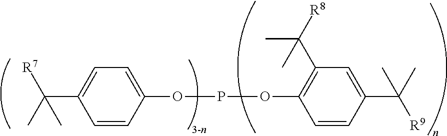
wherein R₇, R₈ and R₉ are independently selected from methyl and ethyl groups, and wherein n is 0, 1, 2 or 3; and/or
wherein the one or more phosphite antioxidants are selected from the group consisting of tris-4-tert-butyl phenyl phosphite; tris 2,4-di-tert-butyl phenyl phosphite; bis(4-tert-butylphenyl)-2,4-di-tert-butylphenyl phosphite; bis(2,4-di-tert-butylphenyl)-4-tert-butylphenyl phosphite; tris 4-tert-pentyl phenyl phosphite; tris 2,4-di-tert-pentyl phenyl phosphite; bis(4-tert-pentylphenyl)-2,4-di-tert-pentylphenyl phosphite; and/or bis(2,4-di-tert-pentylphenyl)-4-tert-pentylphenyl phosphite; and/or
wherein the phosphite antioxidant comprises a blend of at least two, at least three or at least four different phosphite antioxidants, optionally wherein the blend of phosphite antioxidants is a liquid at ambient conditions.

3. The method according to claim 1, wherein the phenolic antioxidant comprises one or more phenolic compounds having the structure of formula II: 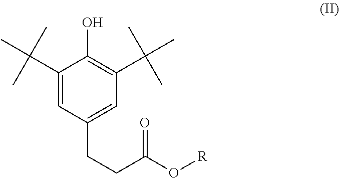
wherein R is a linear or branched alkyl group having from 12 to 20 carbon atoms, from 12 to 15 carbon atoms, or from 13 to 15 carbon atoms.

4. The method according to claim 3, wherein the phenolic antioxidant comprises a mixture of two or more phenolic compounds having the structure of formula II, wherein R is different in each phenolic compound; and/or
wherein the phenolic antioxidant comprises a mixture of two or more phenolic compounds having the structure of formula II, wherein R is different in each phenolic compound and is selected from a linear alkyl group having 12 carbon atoms, a branched alkyl group having 12 carbon atoms, a linear alkyl group having 13 carbon atoms, a branched alkyl group having 13 carbon atoms, a linear alkyl group having 14 carbon atoms, a branched alkyl group having 14 carbon atoms, a linear alkyl group having 15 carbon atoms and/or a branched alkyl group having 15 carbon atoms; and/or
wherein the phenolic antioxidant comprises a mixture of two or more phenolic compounds having the structure of formula II, wherein R is different in each phenolic compound and is selected from a linear alkyl group having 13 carbon atoms, a branched alkyl group having 13 carbon atoms, a linear alkyl group having 14 carbon atoms, a branched alkyl group having 14 carbon atoms, a linear alkyl group having 15 carbon atoms and/or a branched alkyl group having 15 carbon atoms.

5. The method according to claim 1, wherein the phenolic antioxidant comprises C13-C15 linear and branched alkyl esters of 3-(3′5′-di-t-butyl-4′-hydroxyphenyl) propionic acid; and/or
wherein the phenolic antioxidant is a liquid at ambient conditions; and/or
wherein the weight ratio of the phenolic antioxidant to the one or more phosphite antioxidants is from 30:70 to 70:30; from 35:65 to 65:35; from 40:60 to 60:40; from 45:55 to 55:45; or the weight ratio is 50:50; and/or
wherein the stabilising composition is a liquid at ambient conditions.

6. The method according to claim 1, wherein the stabilising composition does not contain any aminic component.

7. The method according to claim 1, wherein the polyol comprises a polyether polyol and/or a polyester polyol; and/or
wherein the polyurethane comprises a polyurethane foam.

8. The method according to claim 1, wherein the one or more phosphite antioxidants are prepared by reacting a phosphorous trihalide with an alkylated phenol or a mixture of alkylated phenols.

9. A stabilised composition, comprising:
a) a polyol and/or a polyurethane; and
b) a stabilising composition comprising:
i. a phenolic antioxidant; and
ii. one or more phosphite antioxidants having the structure of formula I: 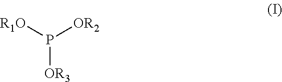
wherein R₁, R₂ and R₃ are independently selected alkylated aryl groups of the structure: 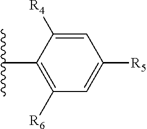
wherein R₄, R₅ and R₆ are independently selected from the group consisting of hydrogen and C₁ to C₆ alkyl, provided that at least one of R₄, R₅ and R₆ is not hydrogen.

10. The stabilised composition according to claim 9, wherein the C₁ to C₆ alkyl is selected from methyl, ethyl, propyl, butyl, pentyl, hexyl, isopropyl, isobutyl, sec-butyl, tert-butyl, isopentyl, tert-pentyl and/or neopentyl; and/or
wherein at least one of R₄, R₅ and R₆ in the phosphite antioxidant is selected from the group consisting of tert-butyl and/or tert-pentyl; and/or
wherein the one or more phosphite antioxidants comprises: 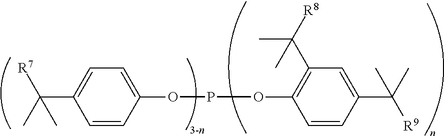
wherein R₇, R₈ and R₉ are independently selected from methyl and ethyl groups, and wherein n is 0, 1, 2 or 3; and/or
wherein the one or more phosphite antioxidants are selected from the group consisting of tris-4-tert-butyl phenyl phosphite; tris 2,4-di-tert-butyl phenyl phosphite; bis(4-tert-butylphenyl)-2,4-di-tert-butylphenyl phosphite; bis(2,4-di-tert-butylphenyl)-4-tert-butylphenyl phosphite; tris 4-tert-pentyl phenyl phosphite; tris 2,4-di-tert-pentyl phenyl phosphite; bis(4-tert-pentylphenyl)-2,4-di-tert-pentylphenyl phosphite; and/or bis(2,4-di-tert-pentylphenyl)-4-tert-pentylphenyl phosphite; and/or
wherein the phosphite antioxidant comprises a blend of at least two, at least three or at least four different phosphite antioxidants, optionally wherein the blend of phosphite antioxidants is a liquid at ambient conditions.

11. The stabilised composition according to claim 9, wherein the phenolic antioxidant comprises one or more phenolic compounds having the structure of formula II: 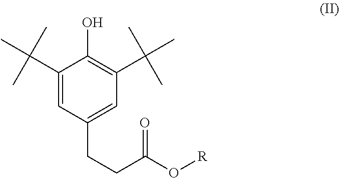
wherein R is a linear or branched alkyl group having from 12 to 20 carbon atoms, from 12 to 15 carbon atoms, or from 13 to 15 carbon atoms.

12. The stabilised composition according to claim 11, wherein the phenolic antioxidant comprises a mixture of two or more phenolic compounds having the structure of formula II, wherein R is different in each phenolic compound; and/or
wherein the phenolic antioxidant comprises a mixture of two or more phenolic compounds having the structure of formula II, wherein R is different in each phenolic compound and is selected from a linear alkyl group having 12 carbon atoms, a branched alkyl group having 12 carbon atoms, a linear alkyl group having 13 carbon atoms, a branched alkyl group having 13 carbon atoms, a linear alkyl group having 14 carbon atoms, a branched alkyl group having 14 carbon atoms, a linear alkyl group having 15 carbon atoms and/or a branched alkyl group having 15 carbon atoms; and/or
wherein the phenolic antioxidant comprises a mixture of two or more phenolic compounds having the structure of formula II, wherein R is different in each phenolic compound and is selected from a linear alkyl group having 13 carbon atoms, a branched alkyl group having 13 carbon atoms, a linear alkyl group having 14 carbon atoms, a branched alkyl group having 14 carbon atoms, a linear alkyl group having 15 carbon atoms and/or a branched alkyl group having 15 carbon atoms.

13. The stabilised composition according to claim 9, wherein the phenolic antioxidant comprises C13-C15 linear and branched alkyl esters of 3-(3′5′-di-t-butyl-4′-hydroxyphenyl) propionic acid; and/or
wherein the phenolic antioxidant is a liquid at ambient conditions; and/or
wherein the weight ratio of the phenolic antioxidant to the one or more phosphite antioxidants is from 30:70 to 70:30; from 35:65 to 65:35; from 40:60 to 60:40; from 45:55 to 55:45; or the weight ratio is 50:50; and/or
wherein the stabilising composition is a liquid at ambient conditions.

14. The stabilised composition according to claim 9, wherein the stabilising composition does not contain any aminic component.

15. The stabilised composition according to claim 9, wherein the amount of stabilising composition is from about 0.01 to about 10%; from about 0.01 to about 5%; or from about 0.01 to about 2% by weight of the polyol and/or polyurethane.

16. The stabilised composition according to claim 9, wherein the polyol comprises a polyether polyol and/or a polyester polyol; and/or
wherein the polyurethane comprises a polyurethane foam.

17. The stabilised composition according to claim 9, wherein the one or more phosphite antioxidants are prepared by reacting a phosphorous trihalide with an alkylated phenol or a mixture of alkylated phenols.

18. A stabilising composition, comprising:
a) a phenolic antioxidant; and
b) one or more phosphite antioxidants having the structure of formula I: 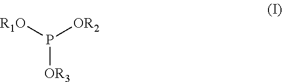
wherein R₁, R₂ and R₃ are independently selected alkylated aryl groups of the structure: 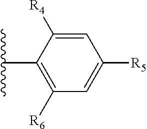
wherein R₄, R₅ and R₆ are independently selected from the group consisting of hydrogen and C₁ to C₆ alkyl, provided that at least one of R₄, R₅ and R₆ is not hydrogen.

19. The stabilising composition according to claim 18, wherein the C₁ to C₆ alkyl is selected from methyl, ethyl, propyl, butyl, pentyl, hexyl, isopropyl, isobutyl, sec-butyl, tert-butyl, isopentyl, tert-pentyl and/or neopentyl; and/or
wherein at least one of R₄, R₅ and R₆ in the phosphite antioxidant is selected from the group consisting of tert-butyl and/or tert-pentyl; and/or
wherein the one or more phosphite antioxidants comprises: 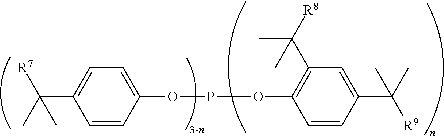
wherein R₇, R₈ and R₉ are independently selected from methyl and ethyl groups, and wherein n is 0, 1, 2 or 3; and/or
wherein the one or more phosphite antioxidants are selected from the group consisting of tris-4-tert-butyl phenyl phosphite; tris 2,4-di-tert-butyl phenyl phosphite; bis(4-tert-butylphenyl)-2,4-di-tert-butylphenyl phosphite; bis(2,4-di-tert-butylphenyl)-4-tert-butylphenyl phosphite; tris 4-tert-pentyl phenyl phosphite; tris 2,4-di-tert-pentyl phenyl phosphite; bis(4-tert-pentylphenyl)-2,4-di-tert-pentylphenyl phosphite; and/or bis(2,4-di-tert-pentylphenyl)-4-tert-pentylphenyl phosphite; and/or
wherein the phosphite antioxidant comprises a blend of at least two, at least three or at least four different phosphite antioxidants, optionally wherein the blend of phosphite antioxidants is a liquid at ambient conditions.

20. The stabilising composition according to claim 18, wherein the phenolic antioxidant comprises a phenol having the structure of formula II: 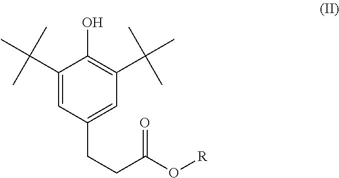
wherein R is a linear or branched alkyl group having from 12 to 20 carbon atoms, from 12 to 15 carbon atoms, or from 13 to 15 carbon atoms.

21. The stabilising composition according to claim 20, wherein the phenolic antioxidant comprises a mixture of two or more phenolic compounds having the structure of formula II, wherein R is different in each phenolic compound; and/or
wherein the phenolic antioxidant comprises a mixture of two or more phenolic compounds having the structure of formula II, wherein R is different in each phenolic compound and is selected from a linear alkyl group having 12 carbon atoms, a branched alkyl group having 12 carbon atoms, a linear alkyl group having 13 carbon atoms, a branched alkyl group having 13 carbon atoms, a linear alkyl group having 14 carbon atoms, a branched alkyl group having 14 carbon atoms, a linear alkyl group having 15 carbon atoms and/or a branched alkyl group having 15 carbon atoms; and/or
wherein the phenolic antioxidant comprises a mixture of two or more phenolic compounds having the structure of formula II, wherein R is different in each phenolic compound and is selected from a linear alkyl group having 13 carbon atoms, a branched alkyl group having 13 carbon atoms, a linear alkyl group having 14 carbon atoms, a branched alkyl group having 14 carbon atoms, a linear alkyl group having 15 carbon atoms and/or a branched alkyl group having 15 carbon atoms.

22. The stabilising composition according to claim 18, wherein the phenolic antioxidant comprises C13-C15 linear and branched alkyl esters of 3-(3′5′-di-t-butyl-4′-hydroxyphenyl) propionic acid; and/or
wherein the phenolic antioxidant is a liquid at ambient conditions; and/or
wherein the weight ratio of the phenolic antioxidant to the one or more phosphite antioxidants is from 30:70 to 70:30; from 35:65 to 65:35; from 40:60 to 60:40; from 45:55 to 55:45; or the weight ratio is 50:50; and/or
wherein the stabilising composition is a liquid at ambient conditions.

23. The stabilising composition according to claim 18, wherein the stabilising composition does not contain any aminic component.

24. The stabilising composition according to claim 18, wherein the one or more phosphite antioxidants are prepared by reacting a phosphorous trihalide with an alkylated phenol or a mixture of alkylated phenols.
